(19) United States
(12) Patent Application Publication
(10) Pub. No.: US 2022/0148211 A1
(43) Pub. Date: May 12, 2022

(54) COMPUTER-IMPLEMENTED METHOD FOR DETERMINING SURFACES IN MEASUREMENT DATA

(71) Applicant: Volume Graphics GmbH, Heidleberg (DE)

(72) Inventors: Christof REINHART, Heidelberg (DE); Thomas GÜNTHER, Heidelberg (DE); Christoph POLIWODA, Heidelberg (DE); Matthias FLESSNER, Heidelberg (DE)

(21) Appl. No.: 17/430,679

(22) PCT Filed: Jan. 13, 2020
(86) PCT No.: PCT/EP2020/050690

§ 371 Date: Aug. 12, 2021

(30) Foreign Application Priority Data
Feb. 12, 2019 (DE) 10 2019 103 429.9

(51) Int. Cl. G06T 7/62; G06T 7/30; G06T 7/00

(52) U.S. Cl. CPC G06T 7/62; G06T 7/0002; G06T 7/30

(57) ABSTRACT

The invention relates to a computer-implemented method for determining surfaces in measurement data from a measurement of a volume which contains an object, a digital representation of the object being produced by means of the measurement data, the object representation having a plurality of pieces of image information of the object, the method comprising the following steps: providing an evaluation specification for at least one predefined three-dimensional region of the volume, said region containing the object; ascertaining the measurement data; defining a subregion of the measurement data that corresponds to the at least one predefined three-dimensional region; and determining at least one surface of the object representation in the subregion. The invention makes the determination of the surfaces of the object representation fast and accurate. Therefore, a computer-implemented method that improves the provision of surface data from the measurement data is provided.

The invention relates to a computer-implemented method for determining surfaces in measurement data from a measurement of a volume containing an object, wherein a digital representation of the object is generated using the measurement data, the object representation comprising a plurality of items of image information of the object.

For the quality assurance of manufactured components, the external and internal characteristics of the components are determined by means of industrial computer tomography in order to detect deviations of the component from the nominal geometry and defects in and on the component. To do this, measurement points are selected during the acquisition of the object geometry or for the application of dimensional measurement technology, in order to define the portions of the measurement data to be examined in which analyses of the geometry are to be performed. Furthermore, the evaluation specification for the at least one predefined three-dimensional region can be derived from information about the nature of a material interface of the object in the at least one predefined three-dimensional region, so that interfaces in and on the component can be determined in the measurement data.

In order to perform a dimensional measurement, information about a specific number of surface points is required. This information may be available, for example, as coordinates. For example, a regular geometry element, which can be a sphere, a circle, or a plane, etc., or a free-form shape, is then fitted to these surface points. The measurement result is then a geometric parameter of the regular geometry element. Taking the example of a circle, the geometric parameter can be, for example, the radius of the circle.

The orientation of the surface can also be represented implicitly, for example by using level sets.

In the case of dimensional measurement technology with computer tomography, the interfaces between the object material and the air or, if present, the interfaces between the materials in the object, must be determined in advance. After the preliminary determination, it is possible to carry out the dimensional measurements directly by suitable selection of fitting points on the surface.

The determination of the entire surface data takes a relatively long time if it is to be carried out with great accuracy. This is usually the case with dimensional measurement technology.

Furthermore, it is not a trivial process to determine the entire relevant surface of a component in advance. Conventional surface-locating algorithms often require a starting contour, e.g. ISO50, but this makes it very difficult to detect all different types of interfaces at the same time with multi-material objects. Strong artefacts can also make it difficult or impossible to determine a suitable starting contour, even for objects from a single material.

DE 10 2005 032 687 A1 describes a method in which a reduced data set of surface points is generated from measurement data by means of an evaluation specification, which data set is compared with a target geometry of a measurement object. The surface data is provided before the evaluation specification is applied.

However, correct segmentation in regions where different materials meet, for example, if different material transitions meet in an extremely small space, is not trivial. Even small details, e.g. narrow bore holes, which are poorly represented in volume data, are often not correctly captured.

The object is therefore to provide a computer-implemented method that improves the provision of surface data from the measurement data.

The main features of the invention are specified in the independent claims 1 and 15. Embodiments of the invention are the subject matter of claims 2 to 14.

In a first aspect the invention relates to a computer-implemented method for determining surfaces in measurement data from a measurement of a volume containing an object, wherein a digital representation of the object is generated using the measurement data, the object representation comprising a plurality of items of image information of the object, and the method comprising the following steps: providing an evaluation specification for at least one predefined three-dimensional region of the volume comprising the object, determining the measurement data, defining a subregion of the measurement data that corresponds to the at least one predefined three-dimensional region, and determining at least one surface of the object representation in the subregion.

The invention thus provides a computer-implemented method that uses information about at least one three-dimensional region of the volume in which the object is located, by means of the evaluation specification, to determine surfaces in the object representation. The computer-implemented method thus uses the information about the three-dimensional region to define subregions of the measurement data in which the surfaces required or to be determined are most likely to be found. The computer-implemented method then determines the surfaces of the object representation in the subregion. The subregion of the measurement data does not necessarily have to be contiguous; rather, the subregion can contain a plurality of separate partial subregions that are assigned to different regions of the object representation.

The surfaces to be determined can include interfaces to the air and interfaces between materials of the object. Furthermore, the evaluation specification can also comprise information about the materials of the interfaces, so that, for example, appropriate specialized analyses for specific materials and/or material combinations can be carried out to determine the surfaces.

Furthermore, the evaluation specification for the at least one predefined three-dimensional region may contain information about multiple edges or corners in the at least one predefined three-dimensional region, i.e., the evaluation specification can contain information about the presence of corners or multiple edges or even small structures on the object. In this way, the analysis can be directed towards finding the corners, multiple edges, or the small structures.

For example, to detect multiple edges or corners, an operator that is dependent on parameters can be applied to measurement points of a grid representation. The operator is designed to determine the location of at least one material interface in the grid representation. In this process the operator takes into account at least the image information items of a subset of the measurement points adjacent to the measurement point in the grid representation.

The surface determination is parameterized in the object representation by means of the analyses to be carried out, wherein the corresponding information about the parameterization can be stored, for example, in the evaluation specification itself or can be derived from the other information in the evaluation specification. Alternatively, the information about the parameterization can be entered manually by a user during the evaluation.

The source of the information can be, for example, a CAD model of the object to be measured, optionally with additional “product and manufacturing information” (PMI) or comparable information, or a programmed measurement plan, wherein the measurement plan can also be used for the automated evaluation of the measurement data.

The evaluation specification can also define, for example, how and on which geometry elements or surface regions the registration, i.e. the determination of the workpiece coordinate system, is carried out, where geometry elements are to be fitted in order to perform dimensional measurements, including specification of a tolerance with regard to dimension, shape and position, in which regions a target-actual comparison or a wall thickness analysis is performed, in which regions analyses with regard to defects, inclusions, porosity, foam structure or a fiber composite analysis are performed, in which regions numerical simulations are performed, such as structural mechanical simulations or the simulation of transport phenomena, or which regions or sectional images, including a representation of the surface, are to be exported as an image file for visual inspection. For example, the latter can be views of regions or geometry elements that are particularly important for the functionality or the structure.

Using the evaluation specification it is thus possible to define the regions in which an exact surface determination is necessary. In the remaining regions, either no surface determination is carried out, or a rapid surface determination with a lower accuracy is carried out, for example by means of a so-called marching cubes algorithm with a fixed ISO50 threshold value.

Performing the surface determination is thus linked locally to the individual analyses of the measurement data to be performed. The analyses to be performed can define the accuracy required at the site of the analysis for the surface determination. In addition, depending on the analysis to be performed, different algorithms can be used for the surface determination in different regions.

The determination of surfaces of the object representation can also be carried out by means of a marching cube algorithm with a defined global threshold value, e.g. ISO50. Alternatively or in addition, locally adaptive methods can be used, which search for local maximum gradients or turning points in a gray-scale curve of measurement data and/or determine local thresholds using the Otsu method, for example. Another alternative or additional method for determining surfaces can be, for example, convolution-based segmentations, for example, using the Canny algorithm. In addition, artificial intelligence can be used as an alternative or additionally for determining the surfaces in the object representation. However, this does not rule out the use of other methods. In addition, the algorithms can also work iteratively in some cases and thus gradually approximate to a final position of the surface.

Furthermore, the surface can be determined by determining at least one single point on the surface. In other words, instead of a closed surface, only at least one point of the surface is determined to define the position of the surface. In this case, it is also possible for a subregion also to contain only a single surface point to be determined.

The invention allows, for example, surfaces in regions where narrow or small elements are represented to be determined with a high degree of accuracy. Furthermore, the accuracy of the surface determination can be matched specifically to the elements of the object to be determined, such as corners or multiple edges. Furthermore, an image processing device or a trained artificial intelligence system can be provided, which automatically identifies geometries or regions in the image information predefined as relevant and triggers a local surface determination on the basis of this selection. In this way, the determination of the surface data is carried out quickly and yet with the locally required accuracy.

According to an example, the method can comprise the following step: determining surfaces outside the subregion with a lower accuracy than inside the subregion.

This means that a closed surface of the object representation always exists after the surface has been determined. This allows a user to more easily orient the position at which a surface of the object representation, determined by the computer-implemented method, is arranged on the measured object using purely visual means. The determination of surfaces with a lower accuracy means that an algorithm is used which typically determines the surface with lower accuracy, but typically also requires significantly less computation time.

In addition, the image information can comprise volume data of the object. The volume data can also be computer-tomographic volume data.

Alternatively or in addition, the evaluation specification can define at least one surface determination method for the at least one predefined three-dimensional region, wherein the surface determination method determines a local extreme value in the measurement data in the at least one predefined three-dimensional region.

By determining local extreme values in the measurement data, very narrow elements, for example, can be detected in the object representation. These narrow elements do not necessarily have to be surfaces, but can be, for example, narrow round grooves or double edges, which are often expressed in the image information as smaller, local gray-scale value variations. Typical single surfaces, on the other hand, are usually expressed as clearly delineable transitions from high to low gray-scale values.

Before defining a subregion of the measurement data corresponding to the at least one predefined three-dimensional region, the method can comprise the following step: performing a coarse alignment of the coordinate system of the measurement data to a coordinate system that matches the evaluation specification.

This allows a time-saving preliminary coarse alignment of the coordinate system of the measurement data to be carried out.

For example, a preliminary, rapid alignment could be performed on the same data set with reduced resolution and/or using a fast but inaccurate algorithm to determine the surface. A reduced resolution can be achieved, for example, by reducing the number of voxels in the volume, pixels in the projection data, and/or the number of projections that are taken into account. This accelerated surface determination can also be achieved by only determining the surface for a low point density. This data is evaluated using known methods, for example, by fitting the calculated, possibly preliminary, surface to a nominal geometry, e.g. a CAD object.

Furthermore, a coarse alignment of the coordinate system can ensure, for example, by means of a defined fixing of the object in the measurement volume, that the object is always in a defined, known pose in the measurement volume.

In a further example of a coarse alignment of the coordinate system, the workpiece coordinate system can be captured by additional sensors, e.g., optical or tactile sensors.

In addition, the coarse alignment can be carried out, for example, on the basis of easily detectable reference points in the volume data. A preliminary surface determination can then be omitted. In one example, these reference points can be salient geometries, such as corners, edges, or spheres. Also, for example, regions with high or characteristic curvature of the surface or characteristic geometry, e.g. repeating geometry, can act as reference points. Thus, characteristics of the object that can be reliably detected are used as reference points.

In another example of coarse alignment, a volume correlation can be provided, which can perform an alignment using a gray-scale-value based determination of the center of gravity and principal axis.

Furthermore, the coarse alignment can be achieved by analyzing projection data, e.g. with prior knowledge of the component geometry, wherein the pose of the component in the volume is determined. For example, the real projection representations are compared with the expected ones, or defined reference points that are easily identifiable in the projection representations are used.

In addition, the coarse alignment can be performed via a manual alignment by a user.

In addition, after the determination of at least one surface of the object representation in the subregion, the method can comprise the following steps: aligning the coarsely aligned coordinate system to a coordinate system that matches the evaluation specification within an evaluation tolerance range based on the at least one surface, wherein the step of aligning the coarsely aligned coordinate system to a coordinate system matching the evaluation specification within the evaluation tolerance range based on the at least one surface, is carried out at least once.

The already coarsely aligned coordinate system can thus be finely aligned in order to enable an exact surface determination. The fine alignment can be carried out by the invention in a time-saving manner By repeating the fine alignment, the coordinate system can be determined as accurately as possible.

Alternatively or additionally, the evaluation specification can be derived from markings made by a user in a preliminary digital object representation after the measurement data has been determined.

The evaluation specification can thus be manually defined by a user during the evaluation of the measurement data by means of the computer-implemented method. In this example, the user can select regions of the object's surface in the preliminary object representation. The preliminary object representation can be determined with reduced resolution or with a fast algorithm, wherein the fast algorithm is faster or less computationally intensive than the surface determination from the step of determining at least one surface of the object representation in the subregion.

The method can also comprise at least one of the following steps: reconstructing volume data from the object representation only in the subregion of the measurement data, and/or loading volume data of only a reconstructed subregion of the object representation into a data memory after an object representation has been at least partially reconstructed from the measurement data, wherein the image information comprises projection data of the object.

Only those voxels or regions of the object representation in which a surface determination or an analysis is to be performed are reconstructed. This can save time for the calculation of the reconstruction. If a reconstruction has already been performed at a previous time, only those data regions in which a surface determination or analysis is to be performed can be additionally loaded. In particular, this minimizes the time required to load the data and the amount of working memory required.

The evaluation specification can comprise an extended predefined three-dimensional region of the volume that comprises the predefined three-dimensional region, wherein after the measurement data has been determined the method comprises the following steps: defining a subregion of the measurement data to be stored that corresponds to the at least one extended predefined three-dimensional region and storing the measurement data of the subregion to be stored in a data memory.

The result of the extended predefined three-dimensional region is to define an environment of the predefined three-dimensional region in addition to the predefined three-dimensional region. Thus, only the volume data of the predefined three-dimensional regions and their environments are stored or archived. This means that not all of the measurement data is stored, but instead only those measurement data items that are of interest for the analyses. This saves time and storage space. Nevertheless, the analyses can still be performed or repeated in a reproducible way, since by storing the environments of the predefined three-dimensional regions all of the local data is available to determine the relevant surface regions.

Furthermore, the definition of a subregion of the measurement data that corresponds to the at least one predefined three-dimensional region may comprise the following sub-steps: defining an extended subregion of the measurement data that corresponds to at least one extended three-dimensional region defined in the evaluation specification, wherein the at least one predefined extended three-dimensional region comprises the at least one predefined three-dimensional region and is larger than the at least one predefined three-dimensional region, and determining all surfaces of the object representation in the extended subregion.

By determining the surfaces of the object representation in the extended subregion, an uninterrupted surface is determined in and around the predefined three-dimensional region, or in the case of partial subregions separated from each other, in and around the predefined three-dimensional regions. This avoids surface determination errors at the edges of the subregion of the measurement data caused by missing information from the surrounding volume data and increases the accuracy of the analysis.

In this case, the determination of at least one surface of the object representation in the subregion can comprise the following step: determining an error range for at least one point of the at least one surface.

The error range contains, for example, information about which error is to be expected when determining the surface. This information is useful for estimating the extent to which the analysis results obtained from the surface, such as dimensional measurements, can be trusted. For example, a characteristic value can be determined, for the quality to be expected of each point of a surface under consideration. This quality can serve as a basis for determining a measurement uncertainty or measurement accuracy. A complex determination of an error range, which can be carried out, for example, using the analysis of the surrounding gray-scale values of the volume data or other meta-information, is thus only carried out for surfaces arranged in the predefined three-dimensional regions. This speeds up the determination of the errors.

In another example, before the step of defining a subregion of the measurement data that corresponds to the at least one predefined three-dimensional region, the method can comprise the following steps: determining at least one preliminary surface in the measurement data, replacing the step of determining at least one surface of the object representation in the subregion by the step of selecting the at least one preliminary surface as the defined surface of the object representation if the at least one preliminary surface is arranged within the at least one predefined three-dimensional region and if the number of the preliminary surfaces corresponds to the number of expected surfaces in the subregion based on the evaluation specification. In the event that the number of preliminary surfaces in a subregion is less than the number of surfaces expected in the subregion on the basis of the evaluation specification, the step of determining at least one preliminary surface in the measurement data is performed in addition to the step of determining at least one surface of the object representation in the subregion. The subregion can be defined on the basis of one or more individual points.

This allows pre-calculated, preliminary surfaces, if available, to be incorporated directly as the surfaces that were otherwise determined by the analyses in the subregion. If these preliminary surfaces are arranged in the predefined three-dimensional region, these surfaces do not need to be re-determined. This will further accelerate the method. If there is no previously determined surface in the required region, the surface or the required point is determined as usual. Furthermore, the evaluation specification can be used for each subregion individually to specify whether an existing surface is used or whether a new surface must be determined.

A still further aspect of the invention relates to a computer program product having instructions executable on a computer, which when executed on a computer cause the computer to carry out the method as claimed in the preceding description.

Advantages and effects as well as extensions of the computer program product arise from the advantages and effects as well as the extensions of the above-described method. In this respect, reference is therefore made to the preceding description.

Further features, details and advantages of the invention result from the wording of the claims, as well as from the following description of embodiments on the basis of the drawings. In the drawings:

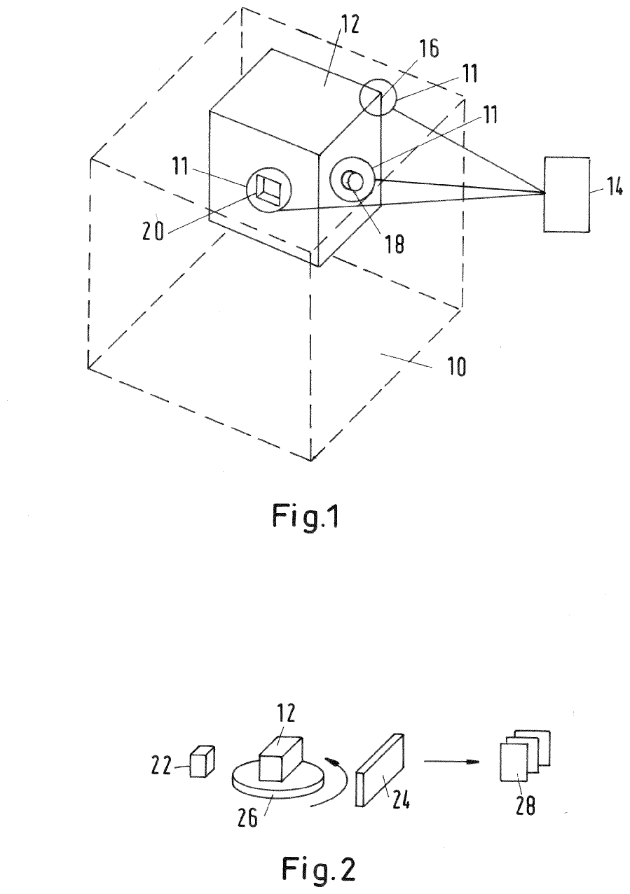

FIG. 1 shows a schematic representation of a volume containing an object, with predefined three-dimensional regions of the volume;

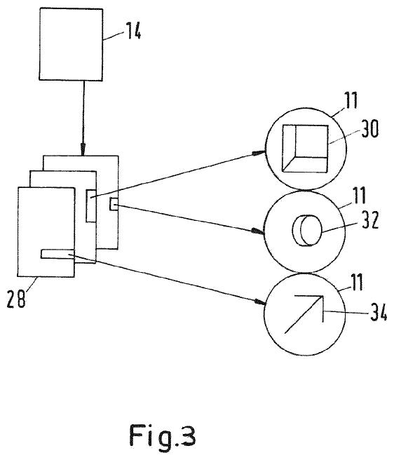

FIG. 2 shows a schematic representation of the determination of measurement data of the object;

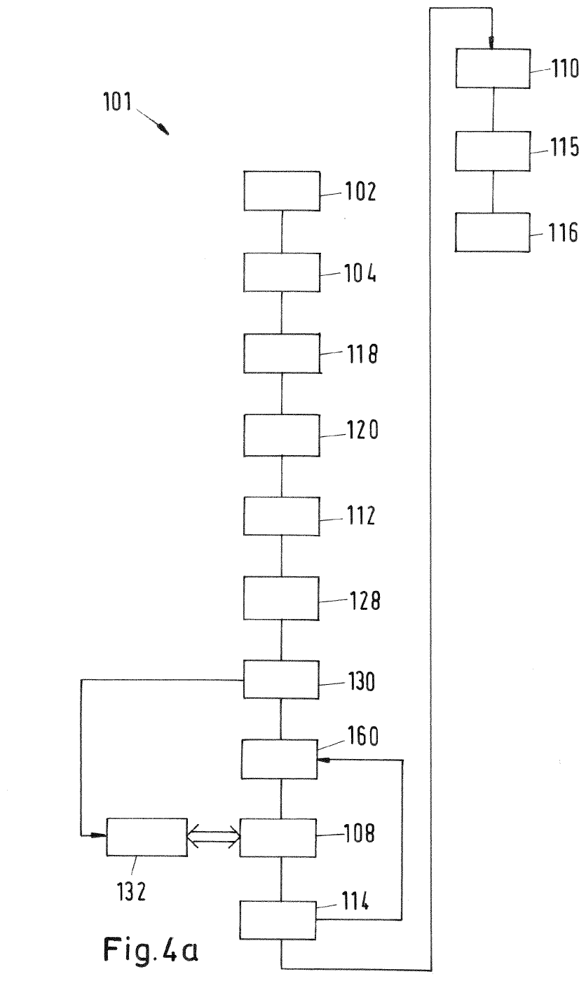

FIG. 3 shows a schematic representation of measurement data corresponding to predefined three-dimensional regions; and

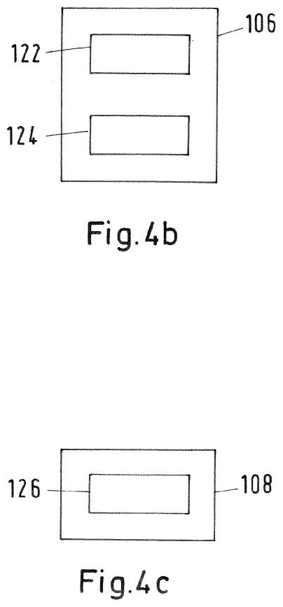

FIG. 4a-c shows a flow diagram and variants of the flow diagram of the computer-implemented method.

FIG. 1 shows a volume 10 in which an object 12 is arranged. The object 12 has at least one surface, with the object 12 comprising a plurality of surfaces. It also comprises predefined three-dimensional regions 11 which at least partially comprise the object 12. The predefined three-dimensional regions 11 can also be arranged within the object 12. Furthermore, the predefined three-dimensional regions 11 may partially comprise the object 12 and partially air in the volume 10 outside the object, so that an outer surface of the object 12 is arranged in the predefined three-dimensional region 11.

In this exemplary embodiment, the predefined three-dimensional regions 11 are, for example, a corner 16 of the object 12, a small sub-element 18 of the object 12, which can also include a material transition on the object 12, or an opening 20, drilled hole or recess in the surface of the object 12. However, other non-illustrated elements of the object 12, such as multiple edges, can be arranged in predefined three-dimensional regions 11. In addition, the example of the corner 16 can be a representation of a corner in a two-dimensional representation, that is, when two edges of a body meet, or a corner of a three-dimensional object where more than two edges meet. When measuring an edge of a cube, the gray-scale values of a CT sectional image, for example, produce a corner, the representation of which is rounded off by the measurement process. The displayed corner 16 therefore will not necessarily have a pointed edge but can be represented as a rounded shape in the object representation.

An evaluation specification 14 contains information about the predefined three-dimensional regions 11 of the volume 10, in which the object 12 is arranged. The evaluation specification 14 can include, for example, the position of the predefined three-dimensional region 11 of the volume 10 in an object coordinate system. Furthermore, planned analyses or algorithms for the evaluation of the predefined three-dimensional range 11 can be included in the evaluation specification 14. These analyses can be, for example, analyses with regard to defects, inclusions, porosity, or foam structure. Alternatively or additionally, the analysis can be a fiber-composite analysis.

Furthermore, the evaluation specification 14 can include information on how a registration is carried out, wherein the registration describes the reference of the object coordinate system relative to the measurement coordinate system in which the measurement data is available. The evaluation specification 14 can also define the geometry elements or surface regions of the object 12 on which the registration is carried out.

The evaluation specification 14 can also include positions to which geometry elements of the object 12 are fitted in order to perform dimensional measurements with regard to dimension, shape, position, ripple, roughness and/or other dimensional parameters. A tolerance or tolerance range can be specified for the results. Numerical simulations such as a structural-mechanical simulation or simulations of transport phenomena can also be specified in the predefined three-dimensional regions 11 by means of the evaluation specification 14.

Furthermore, the evaluation specification 14 can define which regions or sectional images, including a view of the surface, will be exported as image files for a visual inspection. For example, these can be views of particularly critical regions or geometry elements of the object 12.

In an example, the predefined three-dimensional regions can be provided using a CAD model of the object 12. In another example, only subregions of the object 12 can be provided as coordinate sets to define the predefined three-dimensional regions.

FIG. 2 shows a schematic representation of how measurement data can be determined. The determination is shown using the example of a computer tomography device. However, this does not exclude other methods for determining measurement data that generate an object representation. Examples include magnetic resonance imaging, ultrasound and optical coherence tomography.

FIG. 2 shows an X-ray source 22, which emits X-ray radiation through an object 12 arranged on a turntable 26 onto a detector 24. The turntable can rotate the object 360°, for example, to obtain a projection image from every angular position. The detector 24 is used to determine measurement data 28, which are available during the computer tomography in the form of projection images of the object. These projection images of the object 12 can be converted into volume data of the object 12.

According to FIG. 3, the evaluation specification 14 defines subregions in the measurement data 28, which correspond to the predefined three-dimensional regions 11. For example, the subregion 30 of the measurement data 28 corresponds to the predefined three-dimensional region 11 of the object 12, which in FIG. 1 comprises the opening 20. The subregion 32 corresponds to the predefined three-dimensional region 11 which comprises the sub-element 18, and the subregion 34 corresponds to the predefined three-dimensional region 11 of the object 12 which comprises the corner 16.

The subregions 30, 32, 34 of the measurement data 28 are parts of the object representation which may exist in digital form. The object representation comprises a plurality of image information items of the object. Even if the subregions 30, 32, 34 are available individually, information about the position of the individual subregions 30, 32, 34 is typically available in a common coordinate system. A geometric relationship to each other is therefore known.

At least one surface of the object representation is identified in each of the subregions 30, 32, 34. The evaluation specification 14 can define which analyses are carried out in the respective subregions 30, 32, 34 in order to find the corresponding surfaces. Each analysis in the corresponding subregion 30, 32, 34 can be matched to the specific geometries expected in the subregion, such as multiple edges, openings, corners, or partial elements.

FIG. 4a shows a flow diagram of the method 100 for determining surfaces in measurement data from a measurement of a volume that contains an object. The measurement data generates a digital representation of the object, with the object representation comprising a plurality of image information items of the object. The image information can comprise volume data of the object.

In a step 102, the method 100 comprises providing an evaluation specification for at least one predefined three-dimensional region of a volume in which the object is arranged.

As already described above, the evaluation specification provided includes, for example, information on the regions of an object representation in which analyses will be performed and which analyses will be performed in the corresponding regions. This allows specific regions of the volume in which the object is located to be investigated for specific problems. For example, material transitions in or on the object or very narrow parts of the object can be located with special search algorithms and marked.

For this purpose, the evaluation specification can also define at least one surface determination method for the at least one predefined three-dimensional region. The surface determination method can determine a local extreme value in the measurement data in the at least one predefined three-dimensional region. For example, if the measurement data is available as gray-scale values, narrow objects that form a local minimum or local maximum in the profile of the gray-scale values in the measurement data can be detected. For example, narrow round grooves can be detected on the surface of an object, as they are usually represented only as a local maximum of the gray-scale profile in the surface. In this case, it is no longer possible to measure the opposite sides of the surface directly with great accuracy, however, the location or position of the round groove itself is easily determined. The same applies analogously to structures of thin wall thickness, for example lamellas.

Furthermore, the evaluation specification for at least one predefined three-dimensional region may contain information about multiple edges or corners in the at least one predefined three-dimensional region. This means that a specifically selected search algorithm can perform an analysis for multiple edges or corners in the predefined three-dimensional region. The search algorithm can be specified by the evaluation specification. Alternatively, the search algorithm can be defined by an evaluation method that uses the evaluation specification.

Furthermore, the evaluation specification can define the order of magnitude of the geometry to be measured, or the minimum size of the structures of the geometry. It is entirely possible to set different parameters for a surface determination with regard to a filter effect. A strong filter effect reduces the negative influence of noise in the volume data on the result of the surface determination but makes it more difficult to measure small structures correctly. The surface determination can accordingly be locally defined on the basis of the evaluation specification in such a way that different filter effects are possible, while nevertheless ensuring that structures of the required minimum size can be measured locally correctly.

Alternatively or additionally, the evaluation specification for the at least one predefined three-dimensional region can be derived from information describing the type of the material interface of the object in the at least one predefined three-dimensional region. Using computed tomography as an example, materials may be arranged in the object that exhibit a similar attenuation of X-ray radiation. This means that these materials generate similar measurement values as measurement data. Information about the materials can therefore trigger the use of specific analyses which detect material interfaces in the predefined three-dimensional region even in the case of small deviations between the measurement values. In this case, the prior knowledge of the material interface to be identified can thus enable the surface determination to determine the correct material interface with greater accuracy. Furthermore, this allows the possibility of checking whether a material interface of the desired type (e.g., plastic to air or plastic to metal) has been identified after a surface determination. In this way, the validity of the result can be estimated. In addition, the direction of a normal to the surface can be used as prior knowledge. In this way, it can be ensured, in particular in the case of thin-walled structures, that the correct side of a surface is identified, for example.

In a step 104, the measurement data is determined. This can be carried out using any desired method. One example would be to use computed tomography or magnetic resonance imaging to obtain volume data. Another example could be the use of structured light projection or 3D cameras to measure the external surfaces of the object. In another example, existing data can be loaded into memory by determining the measurement data.

In a further alternative or additional example, the evaluation specification can be derived from user markings in the preliminary digital object representation based on a preliminary digital object representation after the measurement data has been determined. The user can then mark regions in the preliminary digital object representation where analyses should take place. Furthermore, the user can specify the analyses to be performed in the respective regions that the user has marked.

Various options are possible for this. For example, a user can mark regions in 2D representations, such as section images, or in 3D representations in which an analysis is to be performed. In a 2D representation, for example, coordinates can be set directly for this purpose. Alternatively, a quick surface determination is carried out in advance, which simplifies the marking by the user. For example, in the case of 3D representations, this procedure allows a point or region on the surface of the object to be marked by clicking a mouse. Similarly, the nearest surface point or region can also be automatically identified and selected by a mouse click in a 2D representation. The desired analysis is then performed based on the selected points or regions. In the case of a dimensional measurement, this can mean, for example, that a preliminary control geometry element is first fitted to the marked regions, which in turn can define an extended evaluation range. In subsequent steps, an exact measurement or fine adjustment of the desired geometry can be carried out, optionally iteratively.

In another option, for example, a selection of desired geometries or regions can be made from a CAD model of the object. After that, a mapping to the measurement data is automatically established.

Alternatively or in addition, a user can select desired geometries or regions in measurement data from other sensors and/or a high-quality reference measurement, or perform an averaging of several measurements, which can also be called the “Golden part”. After this, an automatic mapping to the measurement data can also be performed.

Furthermore, the evaluation specification can define an extended predefined three-dimensional region of the volume, which comprises the predefined three-dimensional region. In this case a surrounding area adjoining the predefined three-dimensional region is combined with the predefined three-dimensional region to form the extended predefined three-dimensional region.

In a further step 118, after the measurement data has been determined, a subregion of the measurement data to be stored in a data memory can be defined. The subregion of the measurement data to be stored then corresponds at least to the extended predefined three-dimensional region.

In a further step 120, the measurement data of the subregion to be stored are stored or saved in a data memory. In this way, an analysis of the subregion can be performed or repeated at a later time to review a previously performed analysis. Saving the environment data of the predefined three-dimensional region in the extended predefined three-dimensional region saves storage space, since only the regions needed for the analyses are stored. In this step, additional information about the pose of the measurement object can optionally be stored in the coordinate system in order to achieve the reproducibility of the measurement data evaluation.

Since the coordinate system in which the measured data is determined does not include a predefined orientation of the object, in step 112, the coordinate system of the measurement data, which corresponds to the measurement coordinate system, can be aligned to an object coordinate system in which the predefined three-dimensional regions of the evaluation specification are defined. This will roughly align the coordinate system of the measurement data to a coordinate system that satisfies the evaluation specification. This corresponds to a registration of the measurement data.

The extended subregion of the measurement data can be used to prevent false evaluations or measurement errors at the edges of the predefined three-dimensional region during the analysis, which can be caused if the environment data is missing. This allows a more accurate analysis of the predefined three-dimensional region.

In a further step 128 at least one preliminary surface can be determined in the measurement data. This surface determination can be applied to the entire set of measurement data. This means that the measurement from step 128 is not limited to a predefined three-dimensional region on the object but can refer to the entire object.

Then, in an additional step 130, it is checked whether the at least one preliminary surface is arranged within the at least one predefined three-dimensional region. For each preliminary surface, it can be checked whether it is arranged in any of the predefined three-dimensional regions of the evaluation specification. If this turns out to be the case, i.e., if one of the preliminary surfaces is arranged in one of the three-dimensional regions, this preliminary surface is assigned to the corresponding three-dimensional region. This means that in step 132, the one preliminary surface is selected as the surface of the object representation determined for the predefined three-dimensional region. Further analysis of the three-dimensional region to which the preliminary surface has been assigned as the determined surface can be avoided by covering all surfaces to be expected in this region by the preliminary surface.

The preliminary surfaces can be determined using very fast surface determination algorithms which are not specifically adapted to the properties of a given predefined three-dimensional region. Normally, the specific analyses in the predefined three-dimensional regions take longer to determine surfaces. Therefore, using steps 128 and 130 can save time if a specific analysis does not need to be performed, since all surfaces of a predefined three-dimensional region have already been found by the fast surface determination procedure.

In a step 106, a subregion of the measurement data can be defined, wherein the subregion of the measurement data corresponds to the at least one predefined three-dimensional region. This is used to divide the measurement data into the sub-regions corresponding to the predefined three-dimensional regions after it has been assigned to specific regions of the object. The subregions correspond to partial surfaces or partial volumes of the object.

With reference to FIG. 4b, step 106 can include the sub-steps 122 and 124. In step 122, an extended subregion of the measurement data can be defined which is larger than the predefined three-dimensional region defined in the evaluation specification and comprises the predefined three-dimensional region. This extended subregion does not necessarily correspond to the extended predefined three-dimensional region. The extended subregion can be larger or smaller than the extended predefined three-dimensional region. The extended subregion can have a continuous surface of the object around a plurality of partial subregions, each comprising a predefined three-dimensional region. In step 124, all surfaces of the object representation can be determined in the extended subregion.

With further reference to FIG. 4a, in step 108 at least one surface of the object representation is determined in the subregion. An analysis defined by the evaluation specification can be carried out to determine the surfaces in the predefined three-dimensional region. If a preliminary surface was already defined in step 130 as the surface to be determined in the predefined three-dimensional region, step 108 may be omitted in favor of step 132 for this predefined three-dimensional region.

With reference to FIG. 4c, step 108 may include sub-step 126, in which an error range for at least one point of the at least one surface is determined. The determination of the error range for a point of the at least one surface is complex and requires considerable computing resources. In step 126 an error range is only determined for surfaces arranged in the predefined three-dimensional regions. This process only determines errors for the regions that are of interest for the analyses or the determination of the surfaces. Step 126 also reduces the computational load and saves time.

With further reference to FIG. 4a, in a step 114, after at least one surface of the object representation has been determined in the subregion and a coarsely aligned coordinate system has been determined using step 112, the coarsely aligned coordinate system can be aligned to a coordinate system that matches the evaluation specification within an evaluation tolerance range based on the at least one surface. The evaluation tolerance range here specifies the extent to which the object coordinate system is allowed to deviate from the measurement coordinate system without the analyses in the predefined three-dimensional regions producing erroneous results. Step 114 thus corresponds to the fine alignment of the coordinate system of the measurement data to the object coordinate system that matches the evaluation specification.

Step 114 can be repeated at least once to increase the accuracy of the alignment of the coarsely aligned coordinate system to the coordinate system that matches the evaluation specification. Step 114 can be further repeated until a measurement coordinate system is found that is within the evaluation tolerance range based on the at least one surface. The repetition of step 114 can be a combination of a repetition of steps 106 and 108 so that after each execution of step 114 new subregions are identified that could not be assigned in the measurement data in a previous alignment of the coordinate system, and further surfaces are determined within it.

In step 110, additional surfaces outside the subregion can be determined with a lower accuracy than within the subregion. In this way, the entire surface of the object in the object representation, i.e. in the measurement data, can be determined. The surfaces outside the predefined three-dimensional regions are determined with low accuracy and are only used for the visual orientation of a user in order to be able to correctly assign the surfaces within the predefined three-dimensional regions to the corresponding regions on the object.

In the event that the object representation is based on projection data, in a step 115 volume data from the object representation which only originates from the subregion of the measurement data can be reconstructed. In this way, only the predefined three-dimensional regions of the object representation that are of interest for the analysis are reconstructed as volume data. This saves computing time.

If a complete object representation has been reconstructed from the measurement data and stored in a data memory, then alternatively or additionally, only volume data from the reconstructed partial region of the object representation stored in the data memory can be loaded. This again saves computing time and reduces the need for working memory.

Furthermore, the measurements and analyses to be carried out can be used as a basis for determining whether and how the determination of surfaces is to be carried out. This means that this information is not only stored directly in the evaluation plan but can also be derived automatically without using the evaluation plan.

Furthermore, when determining the surface, the target of the search is not the nearest surface point, but rather the distance to the nearest surface at the analysis point. By determining the distances, the surfaces determined can be defined by means of a distance field which specifies a distance to the nearest surface for each point.

In another alternative or additional embodiment, a first geometry element of the object can be adjusted using a few sampling points placed, if necessary manually, in the object representation. Based on this, a large number of sampling points are placed evenly distributed across the entire element, which also directly sample the gray-scale values of the object representation in order to measure the element more accurately. This can also be done iteratively. This enables a quick and accurate adjustment of a geometry element by manual operation without the need for an evaluation plan.

Some sampling points can be defined manually. From this, the type of geometry elements that is assumed to be intended by the user can be automatically selected. This geometry element can then be provisionally adjusted. Based on this, as described above a more accurate measurement with a larger number of automatically set sampling points is carried out in turn. This removes the need for the user to pre-define which type of geometry elements are to be adjusted.

To ensure that when automatically resampling the points across the entire geometry element, only points that actually belong to the object are used, the image information at each point is analyzed. Any unusual behavior of the image information causes the point to be discarded. For example, the manually set references could be used for this. This can facilitate the determination of a surface of a circle segment if the measurement data on the opposite side of the circle segment have gray-scale value fluctuations due to other geometries.

The number of sampling points can also be reduced. Thus, the computing time can be further minimized by taking into account the correlation length of the measurement data, which is obtained from a point spreading function, for example. This prevents sampling of an unnecessarily large number of points that do not provide any additional information.

In addition, prior knowledge can be used as to which points of the measurement data should not be sampled due to low data quality. This saves additional computing time and enables more accurate measurement results.

The prior knowledge can be obtained, for example, from an analysis of the volume data, e.g. in the form of signal-to-noise data or a point spreading function. Furthermore, the prior knowledge can be obtained from a statistic derived from a large number of possibly similar measurements, for example in an in- or atline application. In a further example, the prior knowledge can be derived from a simulation of the measuring process which simulates the expected effects of errors, or from surface-based characteristic values which were determined during a previous surface determination, e.g. during the coarse alignment on a low-resolution data set, and are therefore available.

In addition, locally adaptive algorithms for surface determination tend to provide more accurate results for volume data that contains errors. For high-quality volume data without artifacts, it may be more useful to use a global threshold value, because this surface determination can be carried out faster and, in such cases, can sometimes also deliver more accurate results. In one example, a locally adaptive surface determination can be performed only in regions where errors are expected, for example due to a previous simulation, or have been detected using a suitable pattern recognition, and a constant or global threshold value can be used in the remaining regions.

Furthermore, it may not always be necessary, for example in dimensional measurement technology, for control geometry elements to be fitted to the selected surface points. In one example, a distance between two selected points can be specified to determine the thickness of a geometry element of the object.

The method described above can also be implemented as a series of instructions on a computer program product. These instructions can be executed by a computer. When instructions are executed on the computer, the instructions cause the computer to carry out the method according to the description given above.

The invention is not restricted to any one of the embodiments described above but may be modified in a wide variety of ways.

All of the specified features and advantages resulting from the claims, the description and the drawing, including constructional details, spatial arrangements and method steps, can be essential to the invention either in themselves or in the most diverse of combinations.

### LIST OF REFERENCE SIGNS

10 volume
11 predefined three-dimensional regions
12 object
14 evaluation specification
16 corner
18 sub-element
20 opening
22 X-ray source
24 detector
26 turntable
28 measurement data
30 subregion
32 subregion
34 subregion

1. A computer-implemented method for determining surfaces in measurement data from a measurement of a volume containing an object, wherein a digital representation of the object is generated by means of the measurement data, wherein the object representation has a plurality of items of image information of the object, the method comprising the following steps:
providing an evaluation specification for at least one predefined three-dimensional region of the volume, said region comprising the object,
determining the measurement data,
defining a subregion of the measurement data corresponding to the at least one predefined three-dimensional region, and
determining at least one surface of the object representation in the subregion.

2. The method as claimed in claim 1, wherein the method further comprises the following step:
determining surfaces outside the subregion with a lower accuracy than inside the subregion.

3. The method as claimed in claim 1, wherein the image information items comprise volume data of the object.

4. The method as claimed in claim 1, wherein the evaluation specification defines at least one surface determination method for the at least one predefined three-dimensional region, wherein the surface determination method determines a local extreme value in the measurement data in the at least one predefined three-dimensional region.

5. The method as claimed in claim 1, wherein the evaluation specification for the at least one predefined three-dimensional region contains information about multiple edges or corners in the at least one predefined three-dimensional region.

6. The method as claimed in claim 1, wherein the evaluation specification for the at least one predefined three-dimensional region is derived from information about the type of a material interface of the object in the at least one predefined three-dimensional region.

7. The method as claimed in claim 1, wherein before the definition of a subregion of the measurement data that corresponds to the at least one predefined three-dimensional region, the method further comprises the following step:
performing a coarse alignment of the coordinate system of the measurement data to a coordinate system that matches the evaluation specification.

8. The method as claimed in claim 7, wherein after the determination of at least one surface of the object representation in the subregion, the method further comprises the following steps:
aligning the coarsely aligned coordinate system to a coordinate system matching the evaluation specification within an evaluation tolerance range based on the at least one surface,
wherein the step of aligning the coarsely aligned coordinate system to a coordinate system matching the evaluation specification within an evaluation tolerance range based on the at least one surface is performed at least once.

9. The method as claimed in claim 1, wherein the evaluation specification is derived from markings made by a user in a preliminary digital object representation after the measurement data has been determined.

10. The method as claimed in claim 1, wherein the method further comprises at least one of the following steps:
reconstructing volume data from the object representation only in the subregion of the measurement data, and/or
loading volume data of only one reconstructed subregion of the object representation into a data memory after an object representation has been at least partially reconstructed from the measurement data, wherein the image information comprises projection data of the object.

11. The method as claimed in claim 1, wherein the evaluation specification includes an extended predefined three-dimensional region of the volume that comprises the predefined three-dimensional region, wherein the method further comprises the following step after the measurement data has been determined:
defining a subregion to be stored of the measurement data, corresponding to the at least one extended predefined three-dimensional region,
storing the measurement data of the subregion to be stored in a data memory.

12. The method as claimed in claim 1, wherein before the definition of a subregion of the measurement data that corresponds to the at least one predefined three-dimensional region, the method further comprises the following steps:
defining an extended subregion of the measurement data corresponding to at least one extended three-dimensional region defined in the evaluation specification, wherein the at least one predefined extended three-dimensional region comprises the at least one predefined three-dimensional region and is larger than the at least one predefined three-dimensional region, and
determining all surfaces of the object representation in the extended subregion.

13. The method as claimed in claim 1, wherein, the method further comprises the following step after at least one surface of the object representation in the subregion has been determined:
determining an error range for at least one point of the at least one surface.

14. The method as claimed in claim 1, wherein before the step of defining a subregion of the measurement data that corresponds to the at least one predefined three-dimensional region, the method further comprises the following steps:
determining at least one preliminary surface in the measurement data, and
replacing the step of determining at least one surface of the object representation in the subregion by the step of selecting the at least one preliminary surface as the determined surface of the object representation, if the at least one preliminary surface is arranged within the at least one predefined three-dimensional region and if the number of the preliminary surfaces corresponds to the number of expected surfaces in the subregion based on the evaluation specification.

15. A computer program product having instructions executable on a computer, which when executed on a computer cause the computer to carry out the method as claimed in claim 1.
